(19) United States
(12) Patent Application Publication
(10) Pub. No.: US 2026/0116329 A1
(43) Pub. Date: Apr. 30, 2026

(54) SIDE AIRBAG APPARATUS FOR VEHICLES

(71) Applicant: HYUNDAI MOBIS CO., LTD., Seoul (KR)

(72) Inventor: Dong Ho KANG, Yongin-Si (KR)

(73) Assignee: HYUNDAI MOBIS CO., LTD., Seoul (KR)

(21) Appl. No.: 19/251,998

(22) Filed: Jun. 27, 2025

(30) Foreign Application Priority Data
Oct. 25, 2024 (KR) 10-2024-0147540

(51) Int. Cl. B60R 21/231; B60R 21/261

(52) U.S. Cl. CPC B60R 21/23138; B60R 21/261; B60R 2021/2615

(57) ABSTRACT

The present invention relates to an improved side airbag apparatus for vehicles allowing airbag cushions disposed in a first row region and a second row region of an occupant compartment of a vehicle to have the same deployment time and the same deployment direction. A side airbag apparatus for vehicles may include an airbag cushion disposed in a side portion of a seat of a vehicle and an inflator coupled to the airbag cushion and configured to inject gas into an interior of the airbag cushion, wherein the airbag cushion may include a connecting region coupled to the inflator and a rolling region extending from an end of the connecting region, and the rolling region may be bent from the end of the connecting region after rolling is completed.

### CROSS-REFERENCE TO RELATED APPLICATIONS

This application claims priority to and the benefit of Korean Patent Application No. 10-2024-0147540, filed on Oct. 25, 2024, the disclosure of which is incorporated herein by reference in its entirety.

### TECHNICAL FIELD

The present invention relates to a side airbag apparatus for vehicles.

### BACKGROUND

A side airbag apparatus for use in vehicles is an apparatus that inflates and deploys an airbag cushion forward from the side portion of a seat to protect the side of an occupant from the chest to the hip from a door structure of the vehicle. The side airbag apparatus may include an airbag cushion and an inflator that is coupled to the airbag cushion and supplies gas to the interior of the airbag cushion to inflate the airbag cushion. This side airbag apparatus may include a front side airbag apparatus disposed in a first row region including the driver's seat and the passenger's seat, and a rear side airbag apparatus disposed in a second row region, which is a region behind the first row.

Here, in a state in which the inflator is coupled to the airbag cushion, the airbag cushion may be folded in a rolling manner from a portion furthest from a region where the inflator is coupled. In this case, the airbag cushion of the front side airbag apparatus may be rolled in an inboard roll-folding method in a direction in which contact surfaces that come into contact with the occupant are rolled so as to face each other, and the airbag cushion of the rear side airbag apparatus may be rolled in an outboard roll-folding method in a direction in which non-contact surfaces that do not come into contact with the occupant are rolled so as to face each other. That is, the rolling methods of the front airbag cushion and the rear airbag cushion may be different.

In addition, when the inflator is coupled to the airbag cushion, the inflator may enter the interior of the airbag cushion through an insertion hole formed in a contact surface side of the airbag cushion. This may form a difference in a deployment time and a deployment direction of the airbag cushion when the inboard roll-folding and the outboard roll-folding are applied to the front airbag cushion and the rear airbag cushion, respectively.

In particular, the airbag cushion of the side airbag apparatus protrudes from the side portion of the seat of the vehicle and deploys between the seat and a door-side interior. In this case, the airbag cushion roll-folded by the inboard roll-folding method may hit the occupant during deployment, posing a risk of a delay in deployment. Therefore, when a collision accident of a vehicle occurs, occupants in the first and second row regions may not be uniformly protected by the airbag cushions at the same time.

Therefore, there is an increasing need for an improved side airbag apparatus to allow occupants to be uniformly protected by the airbag cushion with the same deployment time and deployment direction in the event of a collision accident of a vehicle.

### SUMMARY

The present invention is directed to providing an improved side airbag apparatus for vehicles so that airbag cushions disposed in a first row region and a second row region of an occupant compartment of a vehicle may have the same deployment time and the same deployment direction.

According to an aspect of the present invention, there is provided a side airbag apparatus for vehicles including an airbag cushion disposed in a side portion of a seat of a vehicle and an inflator coupled to the airbag cushion and configured to inject gas into an interior of the airbag cushion, in which the airbag cushion includes a connecting region coupled to the inflator and a rolling region disposed at an end of the connecting region, and the rolling region is bent from the end of the connecting region after rolling is completed.

The rolling region of the airbag cushion may be disposed to be inclined from the end of the connecting region toward the seat.

At an initial deployment of the airbag cushion, the rolling region of the airbag cushion may be moved toward a door-side interior of the vehicle.

The rolling region of the airbag cushion may be deployed in a state in which the rolling region has been moved toward the door-side interior of the vehicle.

The side airbag apparatus may further include an inner panel disposed inside the airbag cushion and guiding gas generated from the inflator toward a contact panel of the airbag cushion.

The inner panel may include a main body coupled to an inner surface of the airbag cushion and a pass hole formed in the main body and connected to an inner space of the airbag cushion.

The main body of the inner panel may include a first inner portion disposed to face the contact panel of the airbag cushion and a second inner portion disposed to face a non-contact panel of the airbag cushion, and the pass hole of the inner panel may be disposed in the first inner portion.

The side airbag apparatus may further include a cushion cover surrounding the airbag cushion, in which a tear line that allows the cushion cover to be cut when the airbag cushion is deployed is formed on the cushion cover, and the tear line may be disposed in a region facing a door-side interior of the vehicle in a state in which the cushion cover surrounds the airbag cushion.

According to another aspect of the present invention, there is provided a side airbag apparatus for vehicles including an airbag cushion disposed in a side portion of a seat of a vehicle and an inflator coupled to the airbag cushion and configured to inject gas into an interior of the airbag cushion, in which the airbag cushion includes a connecting region coupled to the inflator and a rolling region bent from an end of the connecting region and disposed to be inclined toward the seat from the end of the connecting region, and the rolling region is disposed to be inclined toward a door-side interior of the vehicle by gas generated by the inflator.

The rolling region of the airbag cushion may be deployed in a state in which the rolling region has been moved toward the door-side interior of the vehicle.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exploded view of a side airbag apparatus for vehicles according to one embodiment of the present invention;

FIG. 2 is a view showing a state in which an inflator is coupled to an airbag cushion;

FIG. 3 is an enlarged view of a portion where the inflator is coupled to the airbag cushion;

FIG. 4 is a side view showing a state in which the inflator is coupled to the airbag cushion;

FIG. 5 is a view showing the airbag cushion in a rolled state;

FIG. 6 is a view showing a state in which the airbag cushion in the rolled state is bent;

FIG. 7 is a view schematically showing a state in which a side airbag for vehicles according to one embodiment of the present invention is disposed between a seat and a door-side interior of a vehicle;

FIG. 8 is a view showing a state in which a rolling region of the airbag cushion is disposed close to the door-side interior;

FIG. 9 is a view showing a state in which an inner panel is disposed on the airbag cushion;

FIG. 10 is a cross-sectional view schematically showing a state in which the inflator and the inner panel are coupled to the airbag cushion;

FIG. 11 is a view showing a state in which a cushion cover is coupled to a stud of the inflator; and

FIG. 12 is a view showing a state in which the side airbag apparatus for vehicles coupled to the cushion cover is disposed between the seat and the door-side interior of a vehicle.

### DETAILED DESCRIPTION

Since the present invention may be variously modified and embodied, particular embodiments thereof will be illustrated in the drawings and described. However, this is not intended to limit the present invention to the specific embodiments, and it should be understood to include all modifications, equivalents, and substitutes included in the spirit and scope of the present invention.

Although the terms including ordinal numbers such as first, second, or the like, may be used to describe various elements, these elements are not limited by these terms. These terms are only used to distinguish one element from another element. For example, without departing from the scope of the present invention, a second element could be termed a first element, and similarly, a first element could be termed a second element. The term “and/or” includes a combination of a plurality of related listed items or any of a plurality of related listed items.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are not intervening elements present.

In the description of embodiments, when one element is described as being formed “on” or “under” another element, “on” or “under” includes both a case in which the two elements are directly in contact with each other and a case in which at least one additional element is formed to be disposed between the two elements (indirectly). Further, when expressed as “on or under”, the expression may include the meaning of not only an upward direction but also a downward direction based on one element.

The terms used in the present application are merely provided to describe specific embodiments, and are not intended to limit the present invention. The singular forms are intended to include the plural forms as well unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

Unless otherwise defined, all terms used herein, including technical or scientific terms, have the same meaning as commonly understood by those of ordinary skill in the art to which the present invention belongs. Terms, such as those defined in commonly used dictionaries, should be interpreted as having a meaning that is consistent with their meaning in the context of the related art and will not be interpreted in an idealized or overly formal sense unless expressly so defined herein.

Hereinafter, a side airbag apparatus for vehicles will be described in detail with reference to the accompanying drawings, but identical or corresponding components are denoted by the same reference numerals regardless of figure numbers, and redundant descriptions thereof will be omitted.

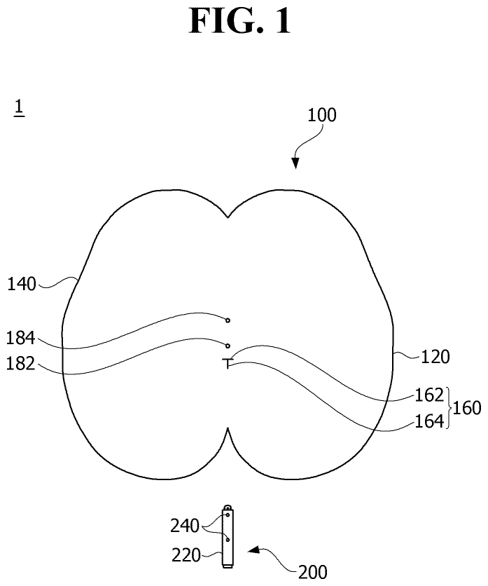

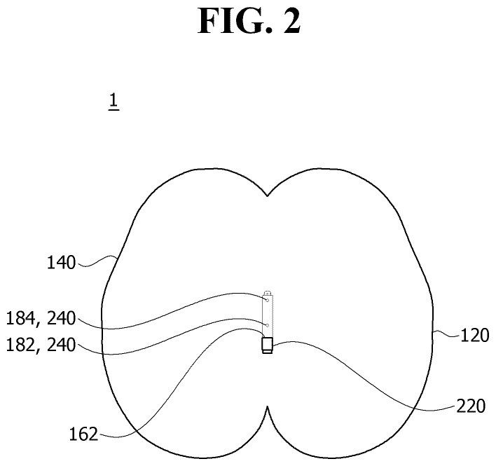

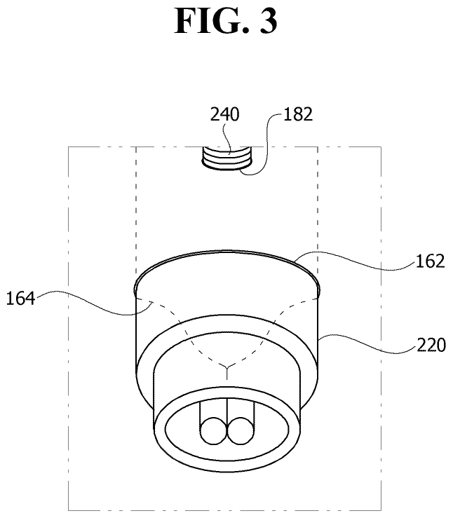

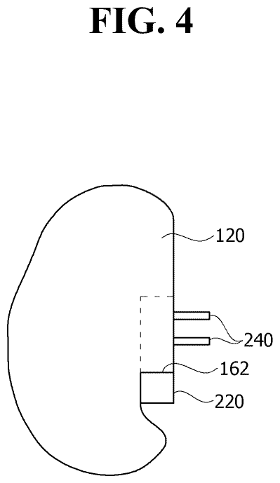

FIG. 1 is an exploded view of a side airbag apparatus for vehicles according to one embodiment of the present invention, FIG. 2 is a view showing a state in which an inflator is coupled to an airbag cushion, FIG. 3 is an enlarged view of a portion where the inflator is coupled to the airbag cushion, and FIG. 4 is a side view showing a state in which the inflator is coupled to the airbag cushion.

Referring to FIGS. 1 to 4, a side airbag apparatus 1 for vehicles according to one embodiment of the present invention may be built into a seat S of a vehicle, and may protrude from the seat S when a collision accident of the vehicle occurs to protrude from the side portion of the seat S in a direction from an occupant compartment of the vehicle toward an engine compartment. This side airbag apparatus 1 for vehicles may include an airbag cushion 100 and an inflator 200.

The airbag cushion 100 may be disposed in a side portion of the seat S of the vehicle. he airbag cushion 100 may be deployed in a space between the seat S and a door-side interior I of the vehicle. Here, the door-side interior I may include a door trim or a side glass coupled to the door trim. In addition, the airbag cushion 100 may be deployed in a direction from the occupant compartment toward the engine compartment. The airbag cushion 100 may be formed by coupling a plurality of panels.

The plurality of panels may include a contact panel 120 and a non-contact panel 140. The plurality of panels may be coupled to each other by sewing in a state in which side portions of the contact panel 120 and the non-contact panel 140 are in contact. In this way, a space for accommodating the gas generated and/or injected from the inflator 200 may be formed inside the airbag cushion 100. Here, the contact panel 120 may be a panel that comes into contact with the body of an occupant when the airbag cushion 100 is deployed, and the non-contact panel 140 may be a panel that does not come into contact with the body of the occupant. The contact panel 120 and the non-contact panel 140 may be provided in a shape symmetrical to each other, as shown in FIGS. 1 and 2. These contact panel 120 and non-contact panel 140 may have a shape in which respective sides thereof are connected to each other, but are not limited thereto. The contact panel 120 and the non-contact panel 140 may be provided as separate panels and then coupled to each other through sewing.

In addition, the airbag cushion 100 may include a cut portion 160, a first coupling hole 182, and a second coupling hole 184.

The cut portion 160 may be a portion of the airbag cushion 100 formed by cutting one region of the airbag cushion 100. The cut portion 160 may be formed in a region where the contact panel 120 and the non-contact panel 140 are connected. The cut portion 160 may form a space through which the inflator 200 may be introduced into the interior of the airbag cushion 100. The cut portion 160 may include a first cut portion 162 and a second cut portion 164.

The first cut portion 162 may be formed in the airbag cushion 100 in a direction intersecting a direction from the first coupling hole 182 to the second coupling hole 184. The second cut portion 164 may have a shape extending from one side of the first cut portion 162.

The second cut portion 164 may be formed in the airbag cushion 100 in a direction intersecting the first cut portion 162 and in the same direction as the direction from the first coupling hole 182 to the second coupling hole 184.

The first coupling hole 182 and the second coupling hole 184 may be formed in the region where the contact panel 120 and the non-contact panel 140 are connected. The first coupling hole 182 and the second coupling hole 184 may be spaced apart from each other. Here, a distance between the first coupling hole 182 and the second coupling hole 184, which are spaced apart, may be the same as a distance between a plurality of studs 240 of the inflator 200 spaced apart from each other, which will be described below. The first coupling hole 182 and the second coupling hole 184 may be used as passages through which the studs 240 of the inflator 200 described below pass.

The inflator 200 may be coupled to the airbag cushion 100, and may inject gas into the interior of the airbag cushion 100. The inflator 200 may include a main body 220 and a stud 240.

The main body 220 (hereinafter referred to as a “first main body 220”) may accommodate a substance that generates gas therein. The first main body 220 may have a hollow cylindrical shape. An exhaust portion through which the gas may be exhausted may be disposed at an end of the first main body 220.

The stud 240 may be disposed on the first main body 220. The stud 240 may protrude from the first main body 220 in a direction perpendicular to a direction in which the first main body 220 is disposed. A plurality of studs 240 may be disposed on the first main body 220, and the plurality of studs 240 may be disposed spaced apart from each other in the direction in which the first main body 220 is disposed.

When a portion of the first main body 220 passes through the cut portion 160 and is introduced into the interior of the airbag cushion 100, the stud 240 may be introduced into the interior of the airbag cushion 100 along the first main body 220. In addition, the stud 240 introduced into the interior of the airbag cushion 100 along the first main body 220 may be disposed at a location where the first coupling hole 182 and the second coupling hole 184 formed in the airbag cushion 100 are disposed. Accordingly, the stud 240 may protrude from an outer surface of the airbag cushion 100 through the first coupling hole 182 and the second coupling hole 184 of the airbag cushion 100, and the inflator 200 may be fixed to the airbag cushion 100.

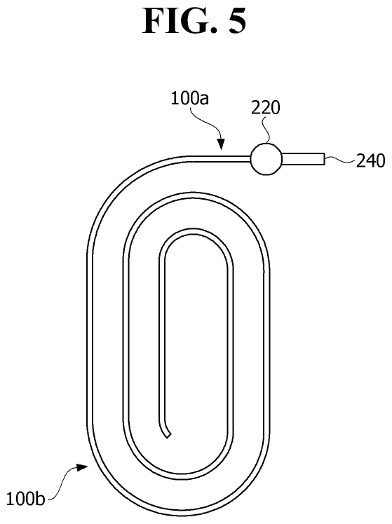

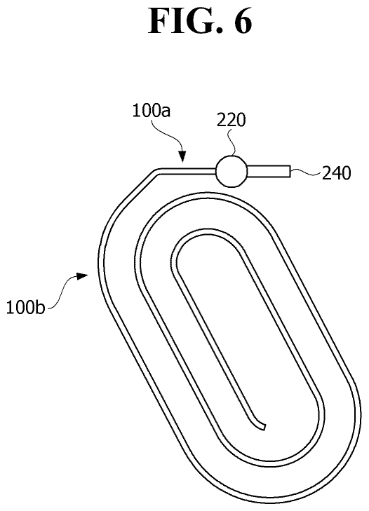

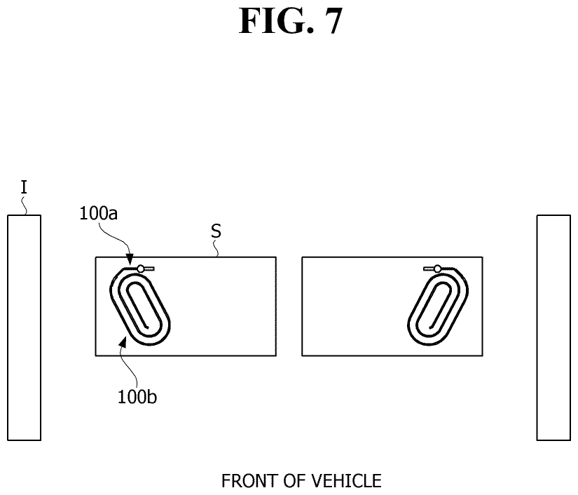

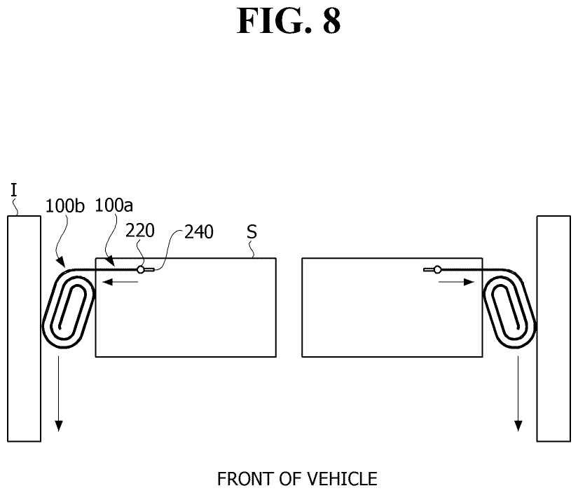

FIG. 5 is a view showing a state in which the airbag cushion is in a rolled state, FIG. 6 is a view showing a state in which the airbag cushion in the rolled state is bent, FIG. 7 is a view schematically showing a state in which a side airbag for vehicles according to one embodiment of the present invention is disposed between a seat and a door-side interior of a vehicle, and FIG. 8 is a view showing a state in which a rolling region of the airbag cushion is disposed close to the door-side interior.

First, as shown in FIG. 4, in the state in which the inflator 200 is coupled to the airbag cushion 100, the airbag cushion 100 may be rolled toward the inflator 200 from a portion furthest from the region coupled to the inflator 200. In this case, the airbag cushion 100 may be rotated and rolled in a direction that causes the contact panels 120 to face each other.

Referring to FIG. 5, the airbag cushion 100 may be divided into a connecting region 100a and a rolling region 100b by a partial region of the rolled airbag cushion 100 as described above. The connecting region 100a is a region coupled to the inflator 200 and may have a straight shape. The rolling region 100b may be disposed at and extending from an end of the connecting region 100a. The rolling region 100b is a region of the airbag cushion 100 to be rolled, and may be unfolded and deployed by the gas generated and/or injected from the inflator 200.

Referring to FIGS. 5, 6, and 7, the rolling region 100b of the airbag cushion 100 may be bent from the end of the connecting region 100a after rolling is completed. Here, the rolling region 100b of the airbag cushion 100 in a bent state may be inclined toward the seat S from the end of the connecting region 100a.

Referring to FIG. 8, due to this inclination, when the gas is generated in the inflator 200, the gas passes through the connecting region 100a of the airbag cushion 100 and reaches the rolling region 100b. In this case, when the gas passes from the connecting region 100a to the rolling region 100b, the rolling region 100b may be moved toward the door-side interior I of the vehicle by the force generated when the gas moves. That is, the inclined position of the rolling region 100b may be changed.

In addition, as described above, in the state in which the rolling region 100b of the airbag cushion 100 is moved so as to be inclined toward the door-side interior I of the vehicle, since the gas is continuously introduced into the rolling region 100b, the rolling region 100b may be deployed in the state in which the rolling region 100b is moved toward the door-side interior I of the vehicle.

In the side airbag apparatus 1 for vehicles according to one embodiment of the present invention as described above, the rolling region 100b of the airbag cushion 100 may be inclined toward the door-side interior I of the vehicle by the gas generated and/or injected from the inflator 200. Accordingly, the phenomenon that the airbag cushion 100 collides with an occupant when the airbag cushion 100 is deployed due to a collision accident may be prevented. This may mean that the delay in deployment of the airbag cushion 100 may be prevented.

In addition, the side airbag apparatus 1 for vehicles according to one embodiment of the present invention may have a structure in which the rolling region 100b of the airbag cushion 100 is rotated and rolled in the direction that causes the contact panels 120 to face each other.

Accordingly, when the rolling region 100b of the airbag cushion 100 is deployed, the phenomenon that the rolling region 100b of the airbag cushion 100 unfolds while facing the door-side interior I may be prevented. Likewise, this may be a structure capable of preventing the delay in deployment of the airbag cushion 100.

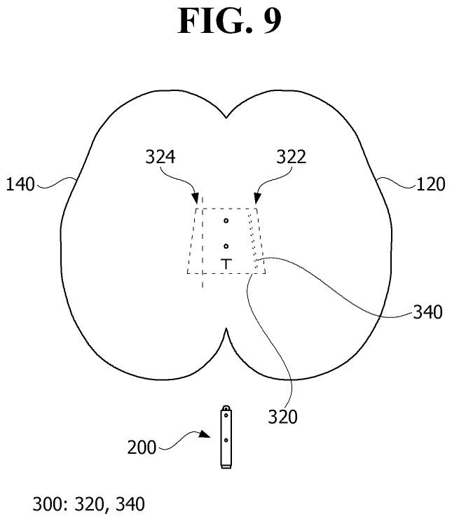

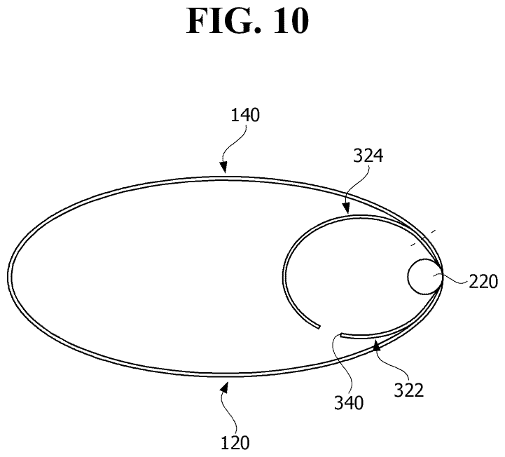

FIG. 9 is a view showing a state in which an inner panel is disposed on the airbag cushion, and FIG. 10 is a cross-sectional view schematically showing a state in which the inflator and the inner panel are coupled to the airbag cushion.

Referring to FIGS. 9 and 10, the side airbag apparatus 1 for vehicles according to one embodiment of the present invention may further include an inner panel 300. The inner panel 300 may be disposed inside the airbag cushion 100, and may guide the gas generated and/or injected from the inflator 200 toward the contact panel 120 of the airbag cushion 100. The inner panel 300 may include a main body 320 and a pass hole 340.

The main body 320 (hereinafter referred to as a “second main body 320”) may be coupled to an inner surface of the airbag cushion 100. The second main body 320 may include a first inner portion 322 facing the contact panel 120 of the airbag cushion 100 and a second inner portion 324 facing the non-contact panel 140 of the airbag cushion 100. Here, the second inner portion 324 of the second main body 320 may be fixed to the non-contact panel 140 of the airbag cushion 100 by sewing. The second main body 320 may form an inner space by coupling the first inner portion 322 and the second inner portion 324 in this way.

In addition, the second main body 320 may have a cut portion 160 disposed at a position overlapping with the cut portion 160 formed in the airbag cushion 100 in the state of being coupled to the inner surface of the airbag cushion 100. Therefore, in the state in which the inner panel 300 is coupled to the airbag cushion 100, the inflator 200 may finally pass through the cut portion 160 formed in the inner panel 300 and enter the interior of the inner panel 300 disposed inside the airbag cushion 100. Accordingly, the second main body 320 may accommodate gas generated and discharged from the inflator 200 therein.

The pass hole 340 may be formed in the main body (second main body 320). More specifically, the pass hole 340 may be formed in the first inner portion 322 of the second main body 320. A plurality of pass holes 340 may be disposed in the first inner portion 322 of the second main body 320, and the plurality of pass holes 340 may be disposed spaced apart from each other. These pass holes 340 may be connected to an inner space of the airbag cushion 100.

The inner panel 300 having such a structure may have a structure that allows gas to be introduced into the interior of the airbag cushion 100 through the pass holes 340 formed in the first inner portion 322 facing the contact panel 120 of the airbag cushion 100. More specifically, when the gas is discharged from the inflator 200, the gas moves inside the inner panel 300.

In this case, the gas may move toward the first inner portion 322 or the second inner portion 324. The gas moving toward the first inner portion 322 enters the interior of the airbag cushion 100 through the pass hole 340. However, the gas moving toward the second inner portion 324 may change its path after colliding with the second inner portion 324 and move toward the first inner portion 322. In this way, the gas passing through the inner panel 300 may move toward the contact panel 120 of the airbag cushion 100.

The inner panel 300 may set a flow path of gas discharged from the inflator 200 to one direction. Since the inner panel 300 guides a movement path of the gas toward the contact panel 120 of the airbag cushion 100 in this way, the phenomenon that the airbag cushion 100 is deployed in a direction opposite to the direction from the occupant compartment to the engine compartment may be prevented. That is, the inner panel 300 may guide the deployment direction of the airbag cushion 100 so that the airbag cushion 100 may be deployed as intended in a design process.

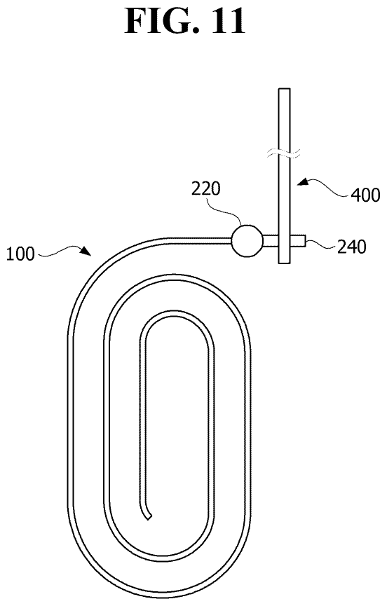

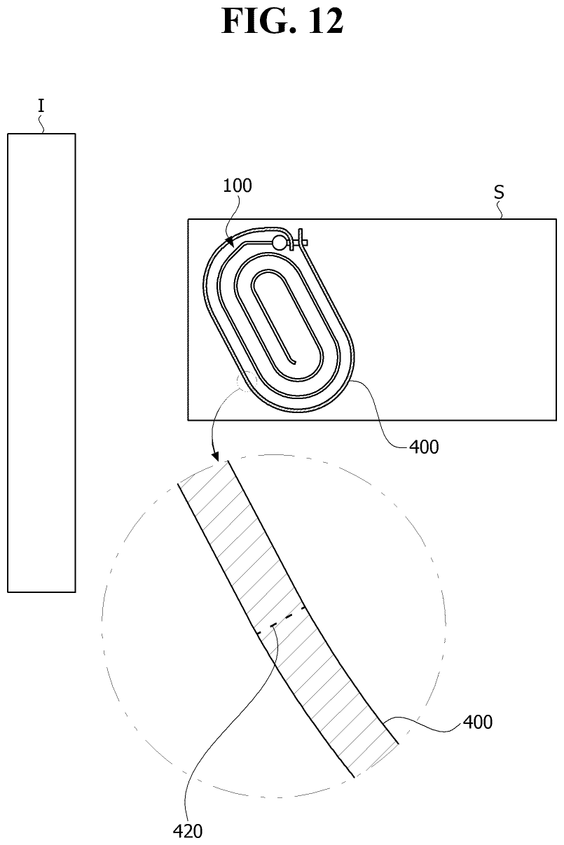

FIG. 11 is a view showing a state in which a cushion cover is coupled to the stud of the inflator, and FIG. 12 is a view showing a state in which the side airbag apparatus for vehicles coupled to the cushion cover is disposed between the seat and the door-side interior of a vehicle.

Referring to FIGS. 11 and 12, the side airbag apparatus 1 for vehicles according to one embodiment of the present invention may further include a cushion cover 400. The cushion cover 400 may have one end fixed to the stud 240 of the inflator 200. In this state, the cushion cover 400 may be moved to surround the airbag cushion 100, and then, the other end thereof may be fixed to the stud 240 of the inflator 200. In this way, the cushion cover 400 may cover the airbag cushion 100 to prevent the airbag cushion 100 from being deployed due to shaking of the vehicle or impact transmitted to the seat S.

The cushion cover 400 may include a tear line 420. The tear line 420 may be formed by cutting a portion of the airbag cushion 100. The tear line 420 may assist the deployment of the airbag cushion 100 so that the airbag cushion 100 may penetrate the cushion cover 400 and protrude outward from the cushion cover 400 during the deployment of the airbag cushion 100.

As shown in FIG. 12, the tear line 420 may be disposed in a region facing the door-side interior I of the vehicle in a state in which the cushion cover 400 surrounds the airbag cushion 100. This is to prevent abnormal deployment of the airbag cover by a portion of the cushion cover 400 that is cut and rotated by the tear line 420. More specifically, when the airbag cushion 100 that is deployed by penetrating the cushion cover 400 is deployed in the direction from the engine compartment toward the occupant compartment, the portion of the cushion cover 400 that is cut and rotated by the tear line 420 may block the movement of the airbag cushion 100 that is deployed in the direction from the engine compartment toward the occupant compartment. In this way, the tear line 420 may block abnormal deployment of the airbag cushion 100.

In particular, when the side airbag apparatus is disposed in the first row region including the driver's seat or the passenger seat, the cushion cover 400 may block abnormal deployment of the airbag cushion 100 to prevent normal deployment of the side airbag that may be deployed in the second row region, which is the region behind the first row region, from being blocked.

According to one embodiment of the present invention, a rolling region of an airbag cushion can be inclined toward a door-side interior of a vehicle by gas generated by an inflator. Accordingly, since the phenomenon of collision with an occupant when the airbag cushion is deployed due to a collision accident can be prevented, a delay in deployment of the airbag cushion can be prevented.

In addition, according to one embodiment of the present invention, a side airbag apparatus for vehicles can include an airbag cushion that has a structure in which an inflator is disposed in a central portion of the airbag cushion and that is folded in a manner of rolling in a direction that causes contact panel rolls to face each other. Therefore, the airbag cushion can have the same deployment time and deployment direction regardless of an installation location.

Although the embodiments of the present invention have been described above, it is understood that one ordinary skilled in the art may make various changes and modifications to the present invention without departing from the spirit and scope of the present invention as hereinafter claimed. Further, it should be construed that differences associated with such changes and modifications fall within the scope of the present invention defined by the accompanying claims.

1. A side airbag apparatus for a vehicle, comprising:
an airbag cushion disposed in a side portion of a seat of the vehicle; and
an inflator coupled to the airbag cushion and configured to inject gas into an interior of the airbag cushion,
wherein the airbag cushion includes:
a connecting region coupled to the inflator; and
a rolling region extending from an end of the connecting region, wherein, before deployment, the rolling region of the airbag cushion is rolled on itself to form a roll, the roll having a greater length than width; and
wherein the roll of the rolling region is disposed at an angle with respect to a door-side interior of the vehicle such that an end of the roll at the connecting region is closer to the door-side interior of the vehicle than is an opposite end of the roll along the length of the roll.

2. The side airbag apparatus of claim 1, wherein the rolling region of the airbag cushion is inclined from the end of the connecting region toward the seat.

3. The side airbag apparatus of claim 1, wherein at an initial deployment of the airbag cushion, the end of the roll of the rolling region of the airbag cushion that is opposite the end at the connecting region is moved toward the door-side interior of the vehicle.

4. The side airbag apparatus of claim 3, wherein the rolling region of the airbag cushion is deployed in a state in which the end of the roll of the rolling region that is opposite the end at the connecting region has been moved toward the door-side interior of the vehicle.

5. A side airbag apparatus for a vehicle, comprising:
an airbag cushion disposed in a side portion of a seat of the vehicle; and
an inflator coupled to the airbag cushion and configured to inject gas into an interior of the airbag cushion,
wherein the airbag cushion includes:
a connecting region coupled to the inflator; and
a rolling region extending from an end of the connecting region,
wherein the rolling region is bent from the end of the connecting region after rolling is completed; and
further comprising an inner panel disposed inside the airbag cushion and configured to first guide the gas injected from the inflator toward a contact panel of the airbag cushion.

6. The side airbag apparatus of claim 5, wherein the inner panel includes:
a main body coupled to an inner surface of the airbag cushion; and
a pass hole formed in the main body and connected to an inner space of the airbag cushion.

7. The side airbag apparatus of claim 6, wherein the main body of the inner panel includes:
a first inner portion facing the contact panel of the airbag cushion; and
a second inner portion facing a non-contact panel of the airbag cushion,
wherein the pass hole of the inner panel is disposed in the first inner portion.

8. The side airbag apparatus of claim 1, further comprising a cushion cover surrounding the airbag cushion and including a tear line that allows the cushion cover to be cut when the airbag cushion is deployed,
wherein the tear line is disposed in a region facing a door-side interior of the vehicle in a state in which the cushion cover surrounds the airbag cushion.

9. A side airbag apparatus for a vehicle, comprising:
an airbag cushion disposed in a side portion of a seat of a vehicle; and
an inflator coupled to the airbag cushion and configured to inject gas into an interior of the airbag cushion,
wherein the airbag cushion includes:
a connecting region coupled to the inflator; and
a rolling region extending from an end of the connecting region, wherein, before deployment, the rolling region of the airbag cushion is rolled on itself to form a roll, the roll having a greater length than width, wherein the roll of the rolling region is disposed at an angle with respect to a door-side interior of the vehicle such that an end of the roll at the connecting region is closer to the door-side interior of the vehicle than is an opposite end of the roll along the length of the roll,
wherein the opposite end of the roll of the rolling region away from the connection region is inclined toward a door-side interior of the vehicle by the gas injected from the inflator.

10. The side airbag apparatus of claim 9, wherein the rolling region of the airbag cushion is deployed in a state in which the rolling region has been moved toward the door-side interior of the vehicle.
